(19) United States
(12) Patent Application Publication
(10) Pub. No.: US 2011/0320024 A1
(43) Pub. Date: Dec. 29, 2011

(54) OPTICAL ELEMENT OF LIGHTING DEVICE AND DESIGN METHOD OF THE SAME

(76) Inventors: Lung-Sheng LIN, Chupei City (TW); Ching-Tsung Ni, Chupei City (TW)

(21) Appl. No.: 13/106,422

(22) Filed: May 12, 2011

(30) Foreign Application Priority Data
Jun. 25, 2010 (TW) 099120895

(51) Int. Cl. G06F 17/50; F21V 5/04; G06F 17/10; F21V 3/02

(52) U.S. Cl. 700/98; 703/2

(57) ABSTRACT

An optical element of a lighting device and a design method of the same are revealed. The optical element is used together with a LED lighting part. The design method includes steps of providing a LED lighting part, selecting a suitable equation used in describing curves and surfaces for simulation test, substituting and changing a plurality of parameters in the equation to run simulation test of the light emitted from the LED lighting part for determining curves and surfaces of the incident surface and the emission surface that satisfy requirements of a specific light distribution pattern. The optical element features on that an air gap is between the incident surface and the LED lighting part. The slope of the incident surface and the slope of the emission surface are of opposite signs on the X-Z surface that passes the origin and γ angle is within 80 degrees around an optical axis of the LED lighting part.

### BACKGROUND OF THE INVENTION

The present invention relates to an optical element of a lighting device and a design method of the same, especially to an optical element in which an incident surface and an emission surface are designed synchronously by simulation test of light from a LED lighting part and an air gap is between the incident surface and the LED lighting part. The slope of the incident surface and the slope of the emission surface are of opposite signs on the X-Z surface that passes the origin and γ angle is within 80 degrees around an optical axis of the LED lighting part.

Solid state lighting has been widely used as light sources of lighting devices such as flashlights, table lamps, vehicle lamps such as headlights, and rear light sets, road lights, or other supplementary lighting devices etc. Take LED road lamps as an example, there are a plurality of fixtures available on the market such as TW262604, TW200507293, US Pub. No. US2005/0243570, U.S. Pat. No. 6,940,660, US Pub. No. US2007/0201225, CN101144863A, CN101556022A, etc. However, the fixtures providing solid state lighting available now have following problems:

1. The fixture has a narrow illumination (beam) angle so that the road surface luminance is with poor uniformity.

2. Coefficient of Utilization Ratio of the street side (SS) and of the house side (HS) is poor. For example, HS:SS=0.5:0.5.

3. The distance between two adjacent street lamps providing solid state lighting is smaller than that of conventional street lamps. Thus more street lamps providing solid state lighting are required within a certain distance of a road.

4. Light distribution of the fixtures is achieved in a mechanical way so that the assembly is getting complicated.

5. Optical shield portion is required to reduce glare of the house side. In order to improve the poor CU ratio, the U.S. Pat. No. 7,618,163 provides a solution—the secondary lens 20 disclosed therein has following features:

1. A compound outer lens surface 24 of the secondary lens 20 includes principal perimeter surface 38 with a ridgeline 42 that subtends an angle greater than 180. degree about a central axis 26 therein and connected to a middle region 50. Middle region 50 has a concavity 46 about reference point 48. A non-principal perimeter surface 39 adjoins the middle region 50 and principal perimeter surface 38. Thus the compound outer lens surface 24 consists of the principal perimeter surface 38, the ridgeline 42, the middle region 50 having the reference point 48 and the concavity 46, and the non-principal perimeter surface 39.

2. While designing the compound outer lens surface 24, the light from LED light emitter 18 refracted by the position lens 16 is not used as a parameter of the simulation test. That means the influence of the primary lens 16 that refracts the light from the LED light emitter 18 is not taken into consideration.

3. The secondary lens 20 has an inner surface 32 which surrounds the primary lens 16. The primary lens 16 and the inner surface 32 are connected by gel. Or the secondary lens 20 is integrated with the LED light emitter 18, without the primary lens 16. While assembling, the secondary lens 20 is glued with the LED light emitter 18 and its inner surface 32 is equal to the emission surface of the primary lens 16 of the LED light emitter 18. Thus the secondary lens 20 is considered without having the incident surface 32. And the incident surface 32 has no effect on the design of the compound outer lens surface 24.

4. Refer to FIG. 16, the compound outer lens surface 24 of the secondary lens 20 is configured by utilizing five target lens design curves 40A-40E and refer to column 7, lines 39-43, each target lens design curves is shaped to satisfy a single or simple set of lens performance criteria along a single direction. Refer to column 7, lines 44-57, firstly define a plurality of target lens design curves 40A-40E extending from the reference point 48, as shown in FIG. 16, FIG. 17C, FIG. 18C, and FIG. 19C. All five target lens design curves 40A-40E have one endpoint at reference point 48. Compound outer lens surface 24 is then completed by generating smooth surfaces between the five target design curves 40A-40E using NURBS (non-uniform, rational B-splines), a mathematical smoothing approach used for CAD-system surfacing and other computer graphics applications and well-known to those skilled in the state of the art of CAD and computer graphics technology.

Thus the compound outer lens surface 24 of the secondary lens 20 in the US7,618,163 is designed independently and directly, without having a corresponding incident surface 32 in matching the inner surface of the secondary lens 20. Moreover, a plurality of target lens design curves 40A-40E extending from the reference point 48 are defined firstly and a smooth surface is generated between the curves using NURBS to complete the compound outer lens surface 24. Thus the device disclosed in U.S. Pat. No. 7,618,163 has following shortcomings:

1. The light distribution pattern generated by the compound outer lens surface 24 includes two elliptical light distribution patterns, as shown in FIG. 20 of U.S. Pat. No. 7,618,163. Thus the rectangular light distribution pattern required by road lamps is unable to attain by the apparatus 10.

2. The incident surface 32 of the secondary lens 20 and the primary lens 16 of the LED light emitter 18 are glued by gel or produced into an integrated part. While assembling the apparatus 10, the secondary lens 20 and the LED light emitter 18 are respectively prepared and integrated with each other by gel. Thus there is an additional gluing and assembling process and the assembling is not completed

3. A road lamp includes a plurality of apparatuses 10. However, after the secondary lens 20 and each LED light emitter 18 being assembled by gel, they are unable to be disassembled. The maintenance and the replacement of the parts are inconvenient.

Moreover, a plurality of equations used in describing curves and surfaces is applied to design a lens such as the secondary lens 20 in U.S. Pat. No. 7,618,163. For example, refer to “Freeform surface modelling” in the free encyclopedia Wikipedia, Polynomial Asphere, XY Polynomial, Spline Surface, etc, these equations are for everyone to use and design various optical surfaces freely. In the optical filed, although a new lens with designed optical surfaces includes some elements similar to the prior arts, it's still a new design in case that not all elements are the same or a main element is different. For example, refer to U.S. Pat. No. 6,837,605 applied on Nov. 27, 2002 by SRAM Opto Semiconductors GmbH and published on Jan. 4, 2005, a lens is revealed in 15A-E. A projective curved surface shown in 14C-E includes a ridgeline arranged at a middle region. This ridgeline and its position are similar to the ridgeline 42 on the compound outer lens surface 24 of the secondary lens 20 disclosed in U.S. Pat. No. 7,618,163. Yet the apparatus revealed in U.S. Pat. No. 7,618,163 still includes other elements such as the middle region 50 having the reference point 48 and the concavity 46 so that the U.S. Pat. No. 7,618,163 has been granted.

Thus there is a need to develop a lighting device with simple structure, higher light efficiency, good uniformity, easy assembling and low cost base on LED light sources.

### SUMMARY OF THE INVENTION

Therefore it is a primary object of the present invention to provide an optical element of lighting devices and a design method of the same. The optical element is used together with LED lighting parts. The optical element includes a concave incident surface facing the LED, and a convex emission surface facing a target area. The surfaces of the incident surface and the emission surface are designed synchronously by simulation test of the light from the LED lighting part. The emission surface satisfies the following conditions: on the X-Z surface that passes the origin (the X-axis is perpendicular to the road direction and the Z-axis is perpendicular to the road surface) and γ angle within 80 degrees (<80 degrees) around an optical axis of the LED lighting part, the slope of the incident surface and the slope of the emission surface are of opposite signs. This is beneficial to the design of the mold and a rectangular light distribution pattern oriented toward the road with a wide illumination angle, good overall luminance uniformity of the road surface, and good CU radio is attained. There is no need to use optical shield portion for reducing glare of the house side, to distribute light in a mechanical way, and the assembly is simplified.

It is another object of the present invention to provide an optical element of lighting devices and a design method of the same in which an air gap is arranged between the incident surface of the optical element and the LED lighting part. The optical element and the LED lighting part are not glued or produced into an integrated part. This is beneficial to respective manufacturing and following assembling of the optical element and the LED lighting part. The maintenance and the replacement of both the optical element and the LED lighting part are also quite convenient.

It is a further object of the present invention to provide an optical element of lighting devices and a design method of the same. The optical element includes a plurality of incident surfaces and corresponding emission surfaces. For example, four incident surfaces and corresponding emission surfaces are arranged in a parallel axial or staggered array to form a multi-lens unit. Thereby the production and assembling are simplified and the cost is down.

The design method of the optical element of the lighting device according to the present invention include following steps: providing a LED lighting part such as a LED lighting part with a hemisphere primary lens but not limited; a point light of the LED lighting part is set as an origin of a coordinate system, (0, 0, 0), x=y=z=0. The X axis is perpendicular to the road direction (from HS to SS), the Y-axis is parallel to the road direction, and the Z-axis is perpendicular to the road surface.

Then select a suitable equation used in describing curves and surfaces such as Polynomial Asphere (following equation (1)), XY Polynomial (following equation (2)), or Spline Surface used for simulation test.

For satisfying requirements of a specific light distribution pattern such as a asymmetrical batwing light distribution pattern whose SS CU radio is larger than HS CU ratio and in rectangular shape oriented forward, substitute and change a plurality of parameters in the equation to run simulation test of the light emitted from the LED lighting part. Thereby the incident surface and the emission surface that satisfy the requirements of the light distribution pattern are determined.

Next make a mold for plastic injection molding according to the incident surface and the emission surface designed above and produce the optical element by plastic injection molding.

### BRIEF DESCRIPTION OF THE DRAWINGS

FIG. 1 is a perspective view of an incident surface of an embodiment of an optical element according to the present invention;

FIG. 2 is a front view of the incident surface of the embodiment in FIG. 1;

FIG. 3 is a cross sectional view along 3-3 line in FIG. 2;

FIG. 4 is a cross sectional view along 4-4 line in FIG. 2;

FIG. 5 is a cross sectional view along 5-5 line in FIG. 2;

FIG. 6 is a cross sectional view along 6-6 line in FIG. 2;

FIG. 7 is a cross sectional view along 7-7 line in FIG. 2;

FIG. 8 is a side view showing slopes of an incident surface and an emission surface of opposite signs in an embodiment of the present invention;

FIG. 9 is a side view showing slopes of an incident surface and an emission surface of opposite signs in another embodiment of the present invention;

FIG. 10 is a perspective view of an embodiment of a multi-lens unit according to the present invention;

FIG. 11 is a front view of the embodiment in FIG. 10;

FIG. 12 is the photometric of an asymmetrical lens with a symmetrical batwing light distribution pattern B and asymmetrical light distribution pattern C generated by an optical element of the present invention;

FIG. 13 is a street light CU ratio curve according to the present invention;

FIG. 14A is a rectangular light distribution pattern oriented forward of the embodiment in FIG. 8;

FIG. 14B is a rectangular light distribution pattern oriented forward of the embodiment in FIG. 9;

FIG. 15A is a perspective view of a curved emission surface with a ridgeline of a lens revealed in U.S. Pat. No. 6,837,605;

FIG. 15B is a front view of a curved emission surface with a ridgeline of a lens revealed in U.S. Pat. No. 6,837,605;

FIG. 15C-FIG. 15E are cross sectional views along M-M line, N-N line, O-O line in FIG. 15B.

### DETAILED DESCRIPTION OF THE PREFERRED EMBODIMENT

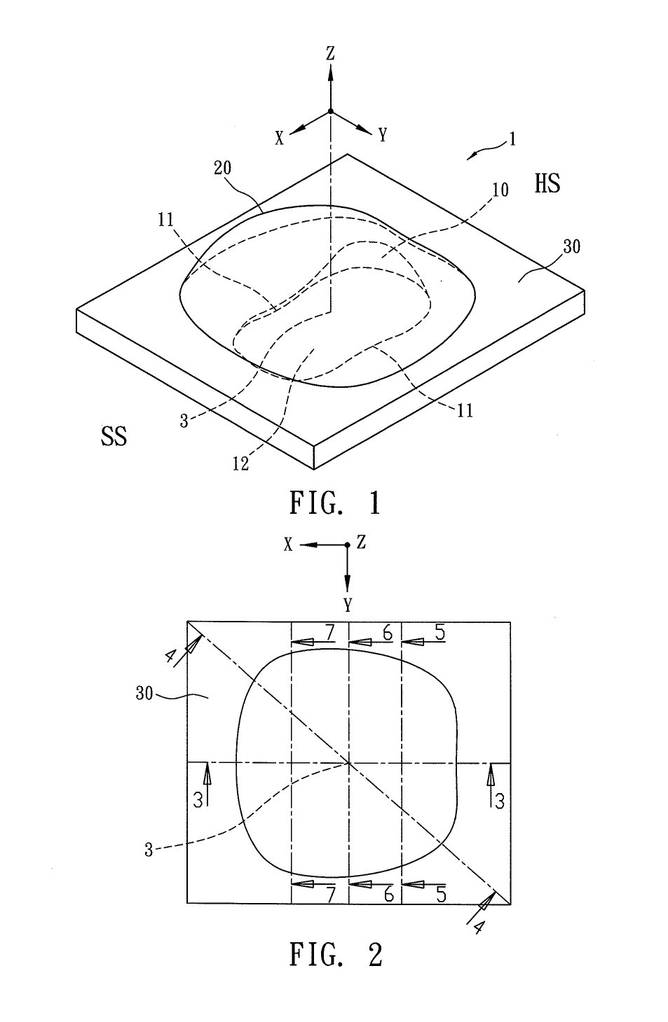

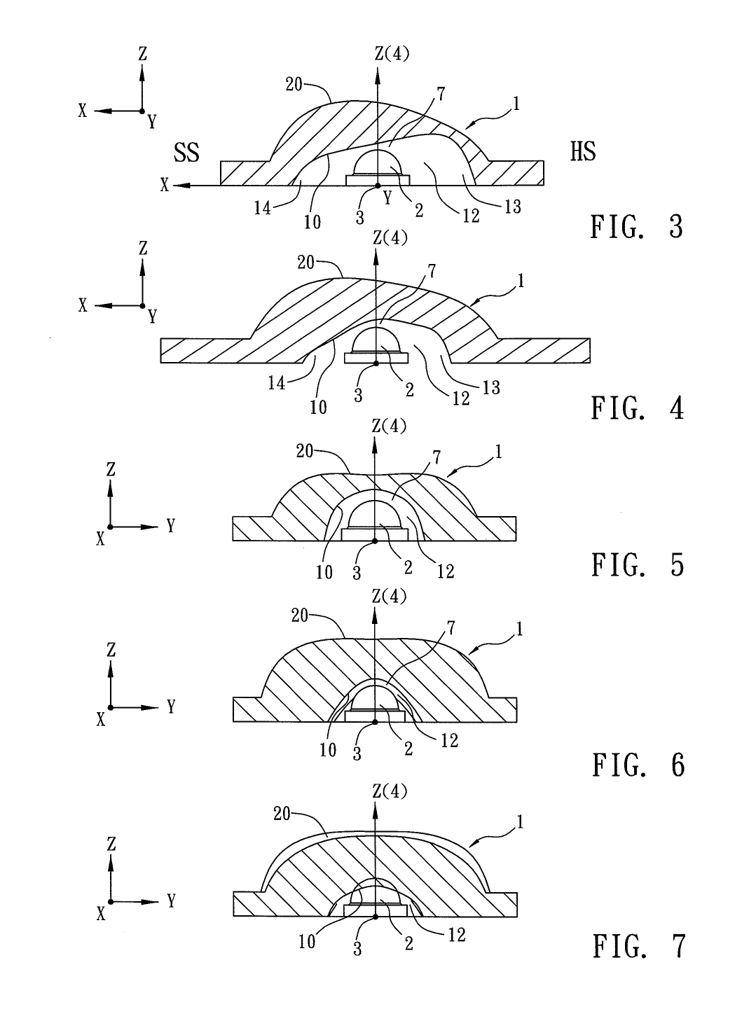

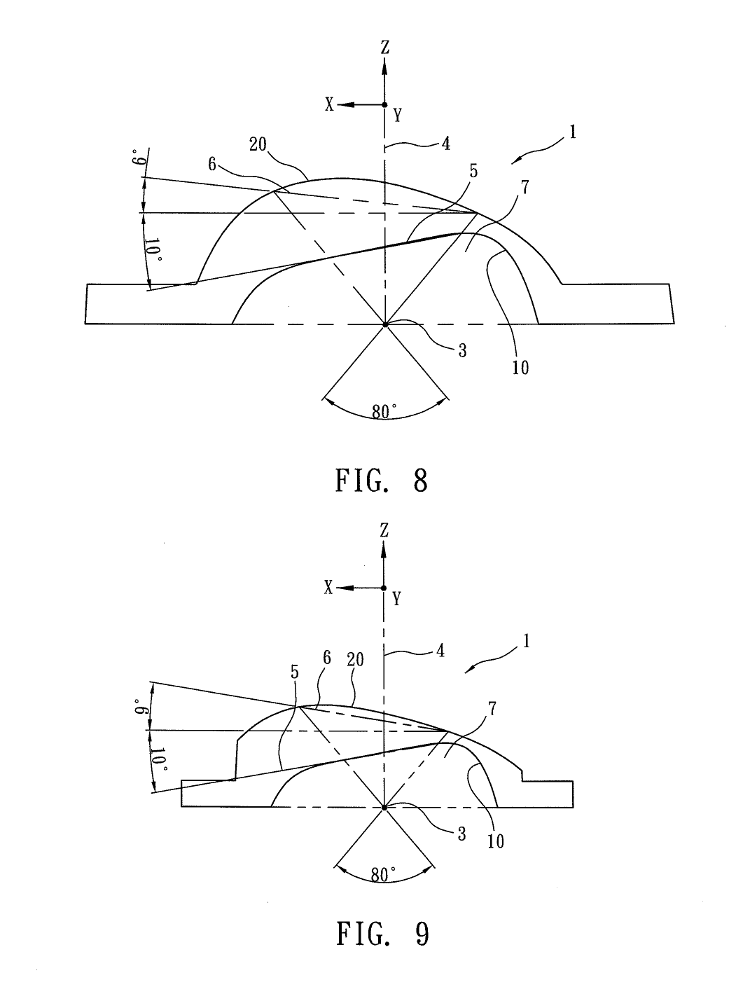

Refer from FIG. 1 to FIG. 7, an optical element 1 of the present invention is used in combination with at least one solid lighting device such as light emitting diode (LED) lighting part 2 so as to form a lighting device used as a street lamp. The optical element 1 includes a concave incident surface 10 facing a LED lighting part 2, and a convex emission surface 20 facing a target area. As shown in FIG. 8, Light emitted from the LED lighting part 2 projects upward along an optical axis 4 (Z-axis) while the light projects downward once the device is used as a street lamp. The divergent light beams move at different angles, toward different directions, passing an air gap 7 as shown from FIG. 3 to FIG. 7, and entering the optical element 1 through a certain position of the incident surface 10. Light beams with different directions pass different positions on the incident surface 10 and enter the optical element 1. After being refracted by the optical element 1, the light beams pass through different positions on the emission surface 20 and project in different directions.

In order to explain the structure and technical features of the optical element 1, a design method of the optical element 1 is firstly described. The design method includes following steps:

Provide a LED lighting part 2. As shown from FIG. 3 to FIG. 7, the LED lighting part 2 is a LED lighting part with a hemispherical primary lens but not limited and a point light of the LED lighting part 2 but not limited is set as an origin 3 of a coordinate system. The coordinates of the origin 3 are always all zero, (0, 0, 0), x=y=z=0, as shown in FIG. 1 and FIG. 2. The X axis is perpendicular to the road direction (from HS to SS), the Y-axis is parallel to the road direction, and the Z-axis is perpendicular to the road surface.

Select a suitable equation used in describing curves and surfaces such as Polynomial Asphere (following equation (1)), XY Polynomial (following equation (2)), or Spline Surface used for simulation test.

$$\begin{matrix}z = \frac{{cr}^{2}}{1 + \sqrt{1 - ( 1 + k ) {c}^{2} {r}^{2}}} + {\sum }_{n = 2}^{10} {C}_{2 n} {r}^{2 n} where {r}^{2} = {x}^{2} + {y}^{2} & Equation ( 1 ) \\ z = \frac{{cr}^{2}}{1 + \sqrt{1 - ( 1 + k ) {c}^{2} {r}^{2}}} + {\sum }_{j = 2}^{66} {c}_{j} {x}^{m} {y}^{n} & Equation ( 2 )\end{matrix}$$

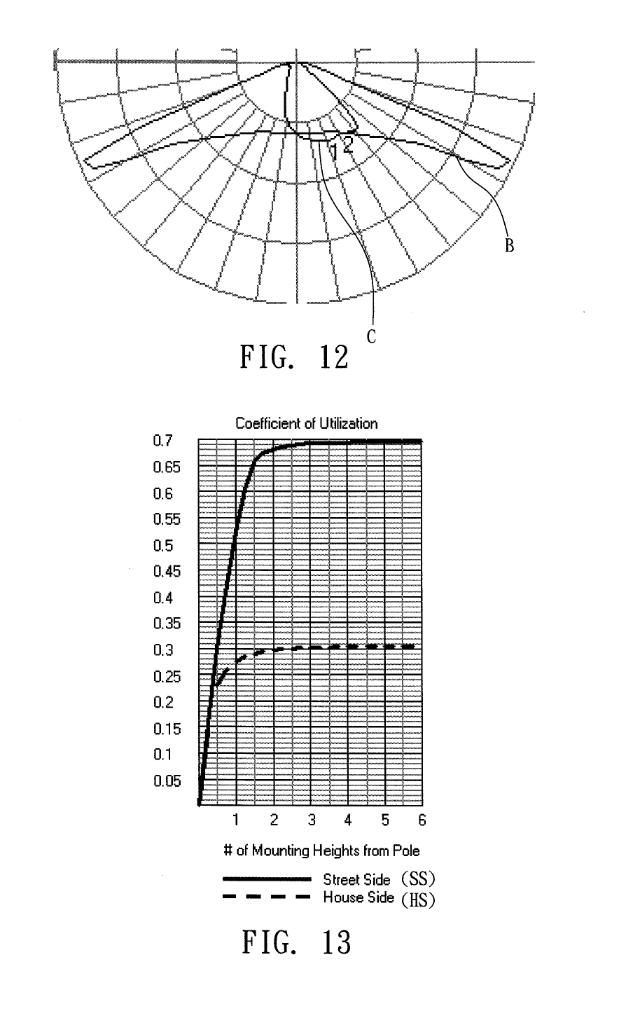

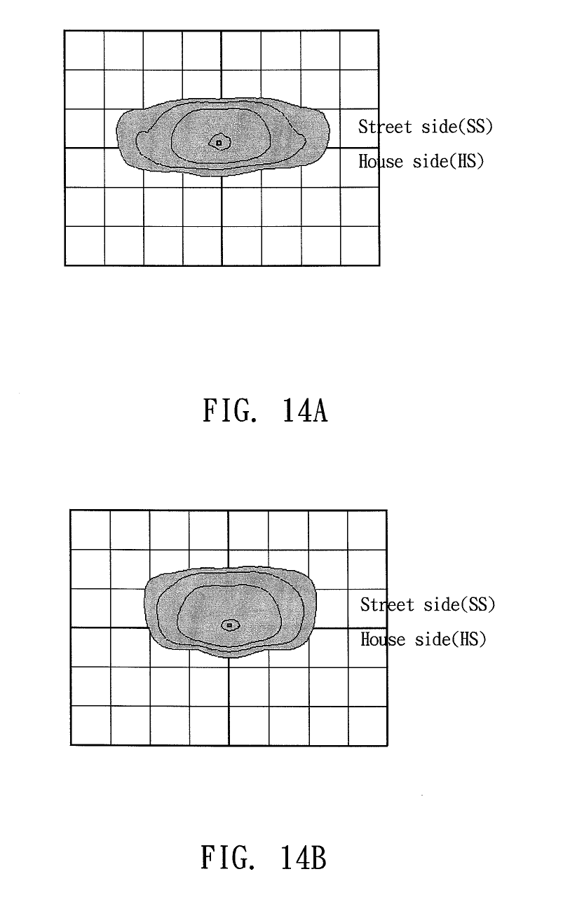

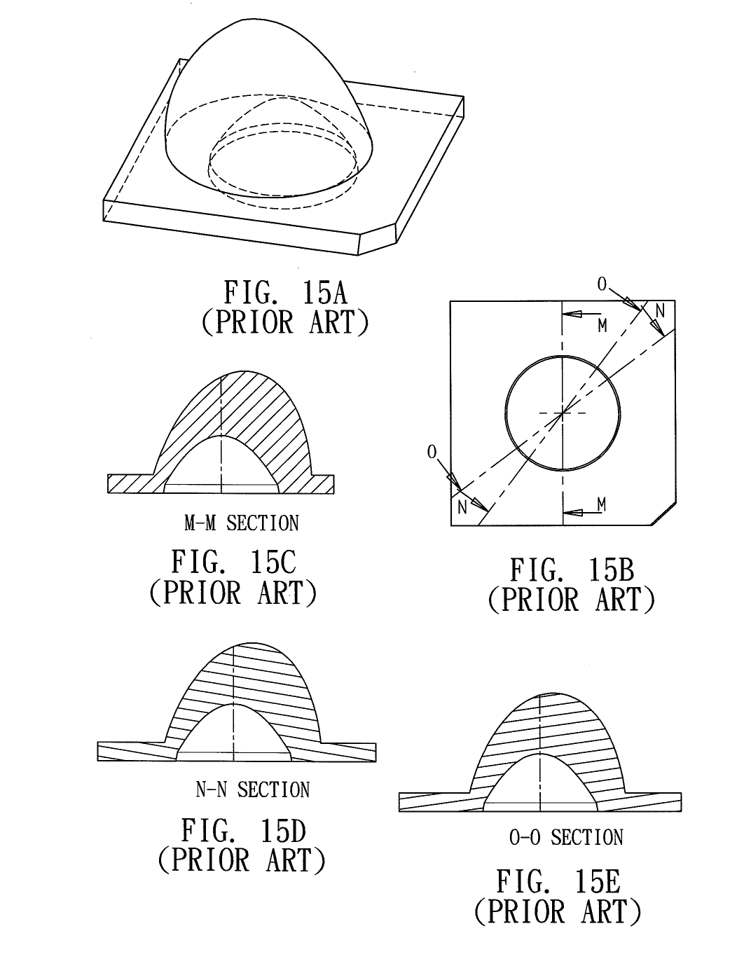

For satisfying requirements of a specific photometric pattern such as an asymmetrical light distribution pattern (as shown in FIG. 12) in which SS CU radio is larger than HS CU ratio (as shown in FIG. 13) and the light distribution pattern is in rectangular shape oriented forward (as shown in FIG. 14), substitute and change a plurality of parameters in the equation describing curves and surfaces for simulation of the light emitted from the LED lighting part 2. Thereby the incident surface 10 and the emission surface 20 that satisfy requirements of the light distribution pattern are determined at the same time, without using NURBS to combine multi-curves for outer lens surface such as U.S. Pat. No. 7,618,163 a utilizing a plurality of target lens design curves 40A-40E extending from the reference point 48. That means during the simulation test, all refractions occurred during the light path of the light emitted from the LED lighting part 2 passing the air gap 7, through the incident surface 10, entering the optical element 1, out of the emission surface 20 and projecting outward are considered as parameters of the simulation design. And all these parameters determine the curves and surfaces of the incident surface 10 and the emission surface 20 that satisfy requirements of the light distribution pattern.

Then according to the curves and surfaces of the incident surface 10 and the emission surface 20, make a mold for plastic injection molding so as to manufacture the optical elements by plastic injection molding.

The incident surface 10 of the optical element 1 produced by above method is a smooth convex continuous curved surface, projecting upward, as shown in FIG. 1. (while being used as road lamps, the optical element is projecting downward, convex downward) and the emission surface 20 is a smooth, recessed continuous curved surface whose inner surface is concave upward and facing downward. The surfaces of the incident surface 10 and the emission surface 20 are determined by a mathematical formula of lens surface and LED lighting part 2. So that, the lens surfaces are not configured by utilizing a plurality of target lens design curves 40A-40E extending from the reference point 48 as shown in U.S. Pat. No. 7,618,163. On the X-Z surface that passes the origin 3 (the X-axis is perpendicular to the road direction and the Z-axis is perpendicular to the road surface) and γ angle within 80 degrees (<80 degrees) around the optical axis 4 of the LED lighting part 2, the slope of the incident surface 10 represented by the number 5 and the slope of the emission surface 20 represented by the number 6 are of opposite signs, as shown in FIG. 3, FIG. 8, and FIG. 9. That means the slope 6 of the emission surface 20 is positive when the slope 5 of the incident surface 10 is negative. As shown in FIG. 8, the slope 5 of the incident surface 10 is sloping down at an angle of 10° (negative value, inclined 10 degrees below the horizontal) while the slope 6 of the emission surface 20 is sloping up at an angle of 6° (positive value, inclined 6 degrees above the horizontal).

As shown in FIG. 9, in another embodiment, the slope 5 of the incident surface 10 is negative, inclined downward at an angle of 10° while the slope 6 of the emission surface 20 is positive, inclined upward at an angle of 9°. The curves of the incident surface and the emission surface change according to the requirement of street lights. Thereby a rectangular light distribution pattern oriented toward the road, with a wide illumination angle, good overall luminance uniformity of the road surface, and good CU radio is attained. There is no need to use optical shield portion for reducing glare of the house side, to distribute light in a mechanical way, and the assembly is simplified.

The optical element 1 finished by the above design method includes an air gap 7 between the incident surface 10 of the optical element 1 and the LED lighting part 2, an air layer, as shown from FIG. 3 to FIG. 7. Thus while assembling, the optical element 1 and the LED lighting part 2 are not glued with each other or integrated, as disclosed in U.S. Pat. No. 7,618,163. This favors respective manufacturing processes and following assembling of the optical element 1 and the LED lighting part 2. This also helps repairs, maintenance and replacement. For example, only part of the optical element 1 and the LED lighting part 2 is replaced.

The shape of the incident surface 10 of the optical element 1 designed by the above design method is like a gourd, with a narrowed middle part 11, as shown in FIG. 1 so that an asymmetrical light distribution pattern whose maximum light intensity is not at the zero point is generated, as shown in FIG. 12, when the optical element 1 is used in combination with the LED lighting part 2. And a proper CU ratio of HS and SS is generated. Refer to FIG. 13, HS:SS=0.3:0.7. Thus the lighting device of the present invention can create a light distribution pattern oriented toward the road with a wide illumination angle, good overall luminance uniformity of the road surface, and good CU radio and there is no need to use optical shield portion for reducing glare of the house side, to distribute light in a mechanical way, and the assembly is simplified.

A plurality of equations of Polynomial Aspheres, XY Polynomials, or spline surfaces used in the design method of the present invention is prior arts (free techniques) in the optical field. By these surface equations, both the incident surface 10 and the emission surface 20 are designed in a synchronous way. Thus the incident surface 10 and the emission surface 20 have a corresponding and coupling relationship. Thus the incident surface 10 and the emission surface 20 have different curvatures along different axes so that light beams emitting from the LED lighting part 2 have different divergence angle and different refractions in different axes. Thus a light distribution pattern meeting the preset requirements is formed.

As shown from FIG. 1 to FIG. 10, the incident surface 10 is a gourd shaped slot 12 symmetrical about the X-axis yet not symmetrical about the Y-axis, with a narrowed middle part 11. The shape of the slot 12 (cross section shape in the XY plane) is gourd-shaped, as shown in FIG. 1 or FIG. 5 to FIG. 7. Moreover, the depths and the curves of the slot 12 along the X-axis are not the same, larger depth from the house side (HS) 13 extending to the smaller depth of the street side (SS) 14, as shown in FIG. 3.

Other non-optical parts on the main body of the optical element 1, as a peripheral part 30 around the incident surface 10 and the emission surface 20, there is no limits on its shape and structure. They can be modified according to assembly requirements of the lighting device.

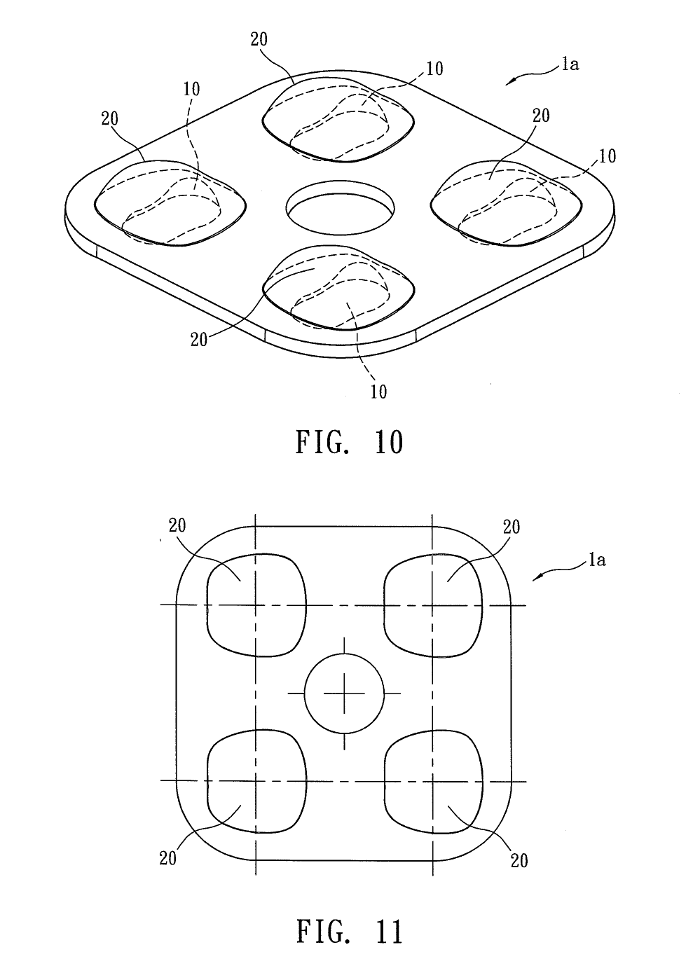

Refer to FIG. 10, FIG. 11, in another embodiment of the present invention, the optical element includes a plurality of incident surfaces 10 and the corresponding emission surfaces 20. For example, the present invention can be an integrated multi-lens unit 1a with four incident surfaces 10 and the corresponding emission surfaces 20 arranged in a parallel axial or staggered array. The multi-lens unit 1a is used in combination with the LED lighting part 2 in a one-to-one relationship. Thus the lighting area of the multi-lens unit 1a is enlarged. This structure also helps manufacturing of the optical elements and assembling of the lighting devices. For example, while assembling an array of lighting devices having 8 columns and 4 rows, four rows of the multi-lens units 1a and two columns of the multi-lens units 1a are assembled so as to simplify production, assembling and reduce the cost.

The shape of the optical element 1, 1a of the present invention is not limited. It can be round or rectangular. Moreover, while forming a lighting device by a plurality of optical elements 1, 1a, the assembling pattern, size, the number of the optical elements and the arrangement way are not restricted, depending on the requirements of the applications. In this embodiment, a road lamp or the like is used as an example, but not intended to limit the present invention. Moreover, the packaging, assembling, light distribution pattern, manufacturing processes and the related circuit design of the LED lighting part 2 are not limited and able to be modified according to the requirements of the usage or the structure.

Compared with U.S. Pat. No. 7,618,163, the optical element of the lighting device and the design method of the same according to the present invention have following difference and advantages:

1. The design of the device in the U.S. Pat. No. 7,618,163 does not take the refraction of the light through the primary lens 16 of the LED 18 as a factor of the simulation test. That means the refraction due to the primary lens 16 of the LED 18 has no effect on the incident surface of the secondary lens and the light distribution pattern. Thus the light distribution pattern is restricted. However, the curves of the incident surface and the emission surface of the present invention use a point light of the LED lighting part 2 but not limited as a coordinate origin. Then select one of the equations used in describing curves and surfaces and changes multiple parameters thereof for simulation design of the light emitted from the LED lighting part 2. Thus the surfaces of the incident surface 10 as well as the emission surface 20 that satisfy the requirements of the light distribution pattern desired are determined synchronously. Thus the incident surface 10 and the emission surface 20 of the present invention are formed by design. The incident surface 10 is able to orient the light forward and adjust the light distribution pattern. Only using the emission surface 20, the functions of the original design are unable to achieve rectangular light distribution with high CU ratio and low glare in house side. The design method and the structure of the present invention can provide a rectangular light distribution pattern oriented forward with a wide illumination angle, good overall luminance uniformity of the road surface, and good CU radio. There is no need to use optical shield portion for reducing glare of the house side and this more energy saving.

2. The incident surface 10 and the emission surface 20 of the present invention are designed synchronously and the surfaces are produced by equations of free technologies. The design method is different from that of the U.S. Pat. No. 7,618,163, which compound outer lens surface 24 is configured by utilizing a plurality of target lens design curves 40A-40E extending from the reference point 48. Moreover, the emission surface 20 of the present invention doesn't includes components corresponding to the components of the compound outer lens surface 24 of the secondary lens 20 such as a principal perimeter surface 38, a ridgeline 42, a middle region 50 having a reference point 48 and a concavity 46, a non-principal perimeter surface 39, etc. The structure of the emission surface of the present invention is different from that of the U.S. Pat. No. 7,618,163.

3. There is an air gap 7 between the incident surface 10 of the optical element 1 and the LED lighting part 2 of the present invention. Thus the optical element 1 and the LED lighting part 2 are not glued with each other integratedly or produced directly into an integrated part. This favors respective manufacturing processes and following assembling of the optical element 1 and the LED lighting part 2. Moreover, the maintenance or replacement is also more convenient.

In use, the present invention at least has following advantages:

1. The optical elements and lighting devices can be produced quickly and easy to assembly. This favors reducing cost of manufacturing and assembly.

2. The optical elements and lighting devices are easily assembled to form fixtures that output various light distribution patterns and different powers. This helps production management and fixture design.

3. The optimal light distribution is achieved by a single optical element. There is no need to distribute light in a mechanical way or by combinations of a plurality of optical elements. The efficiency of the fixture is improved and the diversified design of the fixture is achieved.

4. The device is not easily replicated and the copying is prevented effectively. This is helpful in manufacturing and sales.

5. The proper HS CU ratio and SS CU ratio are attained. There is no need to arrange optical shield portion for reducing glare of the house side. This improves the efficacy of luminaire.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. An optical element of lighting devices used in combination with LED lighting parts comprising an incident surface facing the LED lighting part, and an emission surface facing a target area;
wherein surfaces of the incident surface and the emission surface are formed according to following steps:
providing a LED lighting part and setting a point as a coordinate origin, x=y=z=0; the X axis is from house side to street side and perpendicular to a road direction, the Y-axis is parallel to the road direction, and the Z-axis is perpendicular to a road surface;
selecting an equation used in describing curves and surfaces from free technologies in optical field for simulation test;
substituting and changing a plurality of parameters in the equation according to requirements of a light distribution pattern whose street side CU ratio (Coefficient of Utilization Ratio) is larger than house side CU ratio to run simulation test of light emitted from the LED lighting part for designing the surfaces of the incident surface and the emission surface that satisfy requirements of the light distribution pattern;
wherein the surfaces of the incident surface and the emission surface satisfy the following conditions: on the X-Z surface that passes the origin and γ angle within 80 degrees (<80 degrees) around an optical axis of the LED lighting part, the slope of the incident surface and the slope of the emission surface are of opposite signs; and
an air gap is between the incident surface and the LED lighting part.

2. The device as claimed in claim 1, wherein the equation used in describing curves and surfaces is an equation of Polynomial Asphere, XY Polynomial, or Spline Surface; and the Polynomial Asphere is defined by:
$$z = \frac{{cr}^{2}}{1 + \sqrt{1 - ( 1 + k ) {c}^{2} {r}^{2}}} + {\sum }_{n = 2}^{10} {C}_{2 n} {r}^{2 n} where {r}^{2} = {x}^{2} + {y}^{2}$$
the XY Polynomial is defined by:
$$z = \frac{{cr}^{2}}{1 + \sqrt{1 - ( 1 + k ) {c}^{2} {r}^{2}}} + {\sum }_{j = 2}^{66} {c}_{j} {x}^{m} {y}^{n}$$

3. The device as claimed in claim 1, wherein the point light of the LED lighting part is set as the coordinate origin, x=y=z=0.

4. The device as claimed in claim 1, wherein the slope of the incident surface is negative, sloping down at an angle of 10 degrees, the slope of the emission surface is positive, sloping up at an angle of 6 degrees when the γ angle is within 80 degrees (<80 degrees) around an optical axis of the LED lighting part.

5. The device as claimed in claim 1, wherein the slope of the incident surface is negative, sloping down at an angle of 10 degrees, the slope of the emission surface is positive, sloping up at an angle of 9 degrees when the γ angle is within 80 degrees (<80 degrees) around an optical axis of the LED lighting part.

6. The device as claimed in claim 1, wherein the incident surface is a gourd shaped slot symmetrical about the X-axis yet not symmetrical about the Y-axis and having a narrowed middle part.

7. The device as claimed in claim 6, wherein depths of the gourd shaped slot of the incident surface along the X-axis are not the same.

8. The device as claimed in claim 6, wherein the gourd shaped slot of the incident surface ranges from a house side (HS) with larger depth to a street side (SS) with smaller depth.

9. The device as claimed in claim 1, wherein thickness of projecting curves of the emission surface along the X-axis are not the same.

10. The device as claimed in claim 9, wherein the projecting curves of the emission surface ranges from a house side (HS) with thin thickness to a street side (SS) with thick thickness.

11. The device as claimed in claim 1, wherein the optical elements includes a plurality of incident surfaces and corresponding emission surfaces arranged in an array or in a staggered fashion to form a multi-lens unit.

12. A design method of an optical element as claimed in claim 1, comprising the steps of:
providing a LED lighting part and a point light of the LED lighting part is set as a coordinate origin, x=y=z=0; the X axis is from house side to street side and perpendicular to a road direction, the Y-axis is parallel to the road direction, and the Z-axis is perpendicular to a road surface;
selecting an equation used in describing curves and surfaces from free technologies in optical field for simulation test;
substituting and changing a plurality of parameters in the equation according to requirements of a light distribution pattern to run simulation test of light emitted from the LED lighting part for designing the surfaces of the incident surface and the emission surface that satisfy requirements of the light distribution pattern;
making a mold for plastic injection molding according to the incident surface and the emission surface designed above; and
producing the optical element by plastic injection molding.

13. The method as claimed in claim 12, wherein the equation used in describing curves and surfaces is an equation of Polynomial Asphere, XY Polynomial, or Spline Surface; and the Polynomial Asphere is defined by:
$$z = \frac{{cr}^{2}}{1 + \sqrt{1 - ( 1 + k ) {c}^{2} {r}^{2}}} + {\sum }_{n = 2}^{10} {C}_{2 n} {r}^{2 n} where {r}^{2} = {x}^{2} + {y}^{2}$$
the XY Polynomial is defined by:
$$z = \frac{{cr}^{2}}{1 + \sqrt{1 - ( 1 + k ) {c}^{2} {r}^{2}}} + {\sum }_{j = 2}^{66} {c}_{j} {x}^{m} {y}^{n}$$

14. The method as claimed in claim 12, wherein the point light of the LED lighting part is set as the coordinate origin, x=y=z=0.
